(19) United States
(12) Patent Application Publication
(10) Pub. No.: US 2013/0003340 A1
(43) Pub. Date: Jan. 3, 2013

(54) TERMINAL BLOCK AND ELECTRONICS DEVICE UNIT

(75) Inventors: Kengo Kato, Chiyoda-ku (JP); Kenichi Shimodaira, Kobe-shi (JP)

(73) Assignee: MITSUBISHI ELECTRIC CORPORATION, Chiyoda-ku, Tokyo (JP)

(21) Appl. No.: 13/634,406

(22) PCT Filed: Nov. 25, 2011
(86) PCT No.: PCT/JP2011/077256

§ 371 Date: Sep. 12, 2012

(30) Foreign Application Priority Data
Dec. 8, 2010 (JP) PCT/JP2010/072048

(51) Int. Cl. H01R 9/24

(52) U.S. Cl. 361/823

(57) ABSTRACT

A terminal block includes a top surface formed to be flat, a concave portion formed on the top surface, and a plurality of wiring connecting holes arranged in the concave portion. Wiring display parts corresponding to the wiring connecting holes are arranged on the top surface. The concave portion is arranged in plural for each wiring group. A buttonhole is arranged adjacent to the wiring connecting hole and an opening/closing button for opening and closing a wiring connection fitting located on a bottom part of the wiring connecting hole is accommodated in the buttonhole. The concave portion is a belt-shaped groove.

### FIELD

The present invention relates to a terminal block and to an electronic device unit including a terminal block, a wiring substrate having electronic components mounted thereon, and a case covering the electronic components and the wiring substrate.

### BACKGROUND

Conventionally, there is disclosed an attachment configuration of a terminal name plate of an electronic device as follows. That is, a plurality of electronic devices having a top surface thereof exposed are stacked in a staged manner, each of the electronic devices includes a terminal part and a terminal name part placed on a tip end of a case, the terminal part and the terminal name part are shifted with one another so that the terminal parts and terminal name parts of respective electronic devices are not visually blocked by an electronic device immediately above them, a surface of the terminal name part is inclined, and a terminal name plate is attached on the inclined surface (see, for example, Patent Literature 1).

### CITATION LIST

### Patent Literature

Japanese Utility Model Laid-open Publication No. H02-050974

### SUMMARY

### Technical Problem

However, in the conventional technique described above, a surface of the terminal name part is inclined and a terminal name plate is attached on the inclined surface. In addition, terminal parts and a partition plate partitioning these terminal parts project vertically with respect to the surface of the terminal name part. Therefore, because the projecting terminal parts and partitioning plate become hindrance, it is not possible to print (serigraph) a terminal name on the terminal name part, and thus a terminal name plate has to be attached on the terminal name part. Consequently, there has been a problem that the manufacturing cost of the terminal name plate and the attachment work of the plate cause a cost increase.

The present invention has been made in view of the above problem, and an object of the present invention is to provide a terminal block and an electronic device unit having a wiring display part (terminal name part) on which a wiring name can be printed.

### Solution to Problem

To solve the above described problem and to achieve the object, a terminal block according to the present invention includes: a top surface formed to be flat; a concave portion formed on the top surface; and a plurality of wiring connecting holes provided in the concave portion.

### Advantageous Effects of Invention

The terminal block according to the present invention has a flat top surface on which respective wiring display parts, corresponding to respective wiring connecting holes, can be printed and thus cost reduction can be achieved.

### BRIEF DESCRIPTION OF DRAWINGS

FIG. 1 is a perspective view of an electronic device unit according to a first embodiment of the present invention.

FIG. 2 is a perspective view of a top surface of a terminal block of the electronic device unit according to the first embodiment.

FIG. 3 is a top view of the top surface of the terminal block of the electronic device unit according to the first embodiment.

FIG. 4 is a cross-sectional view along a line A-A in FIG. 3.

FIG. 5 is a perspective view of an electronic device unit according to a second embodiment of the present invention.

FIG. 6 is a cross-sectional view of a terminal block of an electronic device unit according to a third embodiment of the present invention.

FIG. 7 is a cross-sectional view of a terminal block of an electronic device unit according to a fourth embodiment of the present invention.

FIG. 8 is a perspective view of a terminal block of an electronic device unit according to a fifth embodiment of the present invention.

FIG. 9 is a perspective view of a terminal block of an electronic device unit according to a sixth embodiment of the present invention.

### DESCRIPTION OF EMBODIMENTS

Exemplary embodiments of a terminal block and an electronic device unit according to the present invention will be explained below in detail with reference to the accompanying drawings. The present invention is not limited to the embodiments.

### First Embodiment

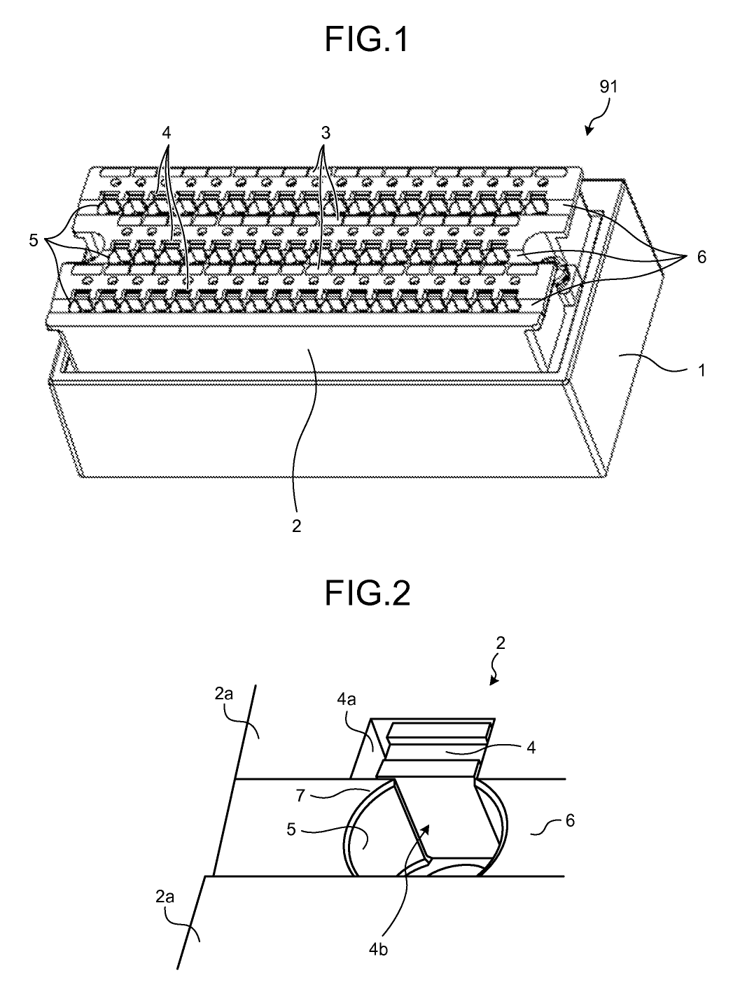

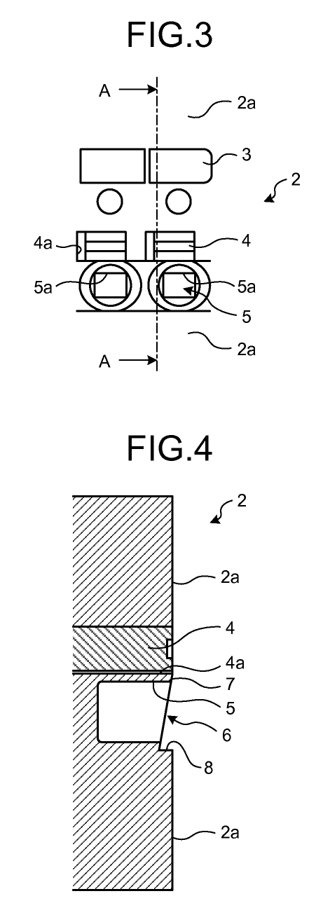

FIG. 1 is a perspective view of an electronic device unit according to a first embodiment of the present invention, FIG. 2 is a perspective view of a top surface of a terminal block of the electronic device unit according to the first embodiment, FIG. 3 is a top view of the top surface of the terminal block of the electronic device unit according to the first embodiment, and FIG. 4 is a cross-sectional view along a line A-A in FIG. 3.

An electronic device unit 91 according to the first embodiment includes a wiring substrate (not illustrated) having electronic components (not illustrated) and a terminal block 2 in a rectangular board shape mounted thereon, and a case 1 in a rectangular parallelepiped box shape covering the electronic components and the wiring substrate.

A top surface 2a of the terminal block 2 has no projections or the like and is formed to be flat. On the top surface 2a of the terminal block 2, belt-shaped grooves 6 as concave portions are formed for each wiring group that is connected to the terminal block 2. Three grooves 6 as concave portions are formed for three wiring groups.

In each of the grooves 6, a plurality of wiring connecting holes 5 having a wiring connection fitting 5a located on a bottom part thereof are provided. The wiring connection fitting 5a clamps a conductor of a wire from which insulating coating is peeled off, and electrically connects the wire and the electronic device unit 91. Wires in the same group are connected to the wiring connecting holes 5 provided in one of the grooves 6. Because the wires in the same group are connected to the wiring connecting holes 5 provided in one of the grooves 6, erroneous wiring can be prevented.

A rectangular buttonhole 4a is provided adjacent to each of the wiring connecting holes 5. An opening/closing button 4 for releasing a wire by opening the wiring connection fitting 5a with a pressing operation is accommodated in the buttonhole 4a.

The wiring connecting hole 5 and the buttonhole 4a are formed to be partially overlapped, and the overlapped part serves as a rectangular communication opening 4b. An edge part 7 provided between the wiring connecting hole 5 and the buttonhole 4a supports the opening/closing button 4 such that the opening/closing button 4 does not fall into the wiring connecting hole 5. Arrays of respective wiring display parts 3 corresponding to respective wiring connecting holes 5 are provided in parallel to the belt-shaped grooves 6 in the vicinity of each of the buttonholes 4a of the flat top surface 2a of the terminal block 2.

A bottom surface of the belt-shaped grooves 6 is formed to be an inclined surface, which has a downward inclination toward the width direction with respect to a direction to be away from the buttonhole 4a. An edge part of the groove 6 further from the buttonhole 4a is formed to be a stepped part 8. An edge part of the groove 6 closer to the buttonhole 4a is continuous to the top surface 2a of the terminal block 2. By arranging the inclined surface and the stepped part 8 in the groove 6, it is possible to make the groove 6 to be conspicuous and this is useful for preventing erroneous wiring.

Because the wiring connecting holes 5 are provided in the belt-shaped grooves 6 and the opening/closing button 4 is accommodated in the buttonhole 4a, there is no projection from the top surface 2a of the terminal block 2. Therefore, terminal names can be printed on all of the wiring display parts 3 arranged on the flat top surface 2a of the terminal block 2 by one printing process (serigraph).

### Second Embodiment

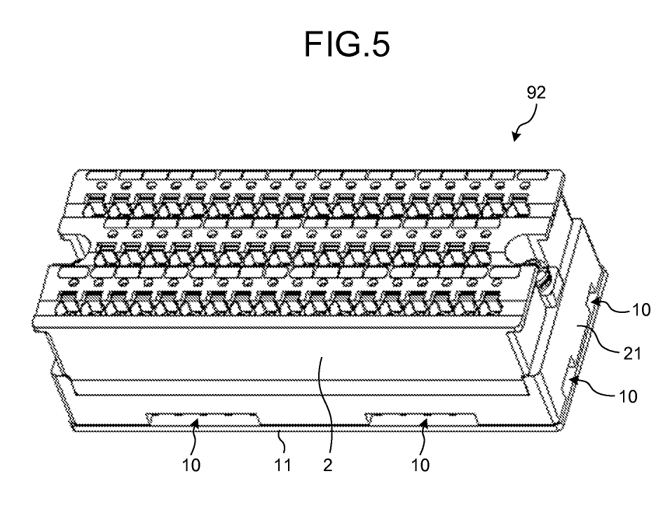

FIG. 5 is a perspective view of an electronic device unit according to a second embodiment of the present invention. An electronic device unit 92 according to the second embodiment includes a terminal block 2 that is equivalent to the terminal block 2 of the electronic device unit 91 according to the first embodiment. In the electronic device unit 92 according to the second embodiment, electronic components (not illustrated) that cannot be mounted on a wiring substrate 11 due to overflow are mounted on a bottom surface of the terminal block 2, and a plurality of ventilation holes 10 are provided in a case 21.

In the electronic device unit 92 according to the second embodiment, it is possible to mount a larger number of electronic components caused by diversified functions of the electronic device unit 92 without increasing the number of the wiring substrates 11 or without increasing the size of the electronic device unit 92. In addition, because the ventilation holes 10 are provided in the case 21, an excellent heat releasing characteristic can be realized.

### Third Embodiment

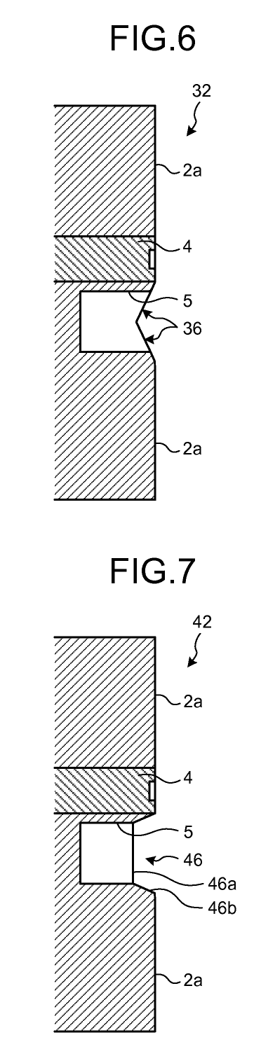

FIG. 6 is a cross-sectional view of a terminal block of an electronic device unit according to a third embodiment of the present invention. As illustrated in FIG. 6, the top surface 2a of a terminal block 32 according to the third embodiment has no projections or the like and is formed to be flat. On the top surface 2a of the terminal block 32, a belt-shaped groove (a concave portion) 36 is formed for each wiring group that is connected to the terminal block 32. The belt-shaped groove 36 is a V-shaped groove having a downward inclination toward the center in the width direction.

Except for the shape of the groove (the concave portion) 36, features of the terminal block 32 according to the third embodiment are identical to those of the terminal block 2 according to the first embodiment. By forming the groove 36 to be a V-shaped groove, the groove 36 becomes conspicuous and erroneous wiring can be prevented. Furthermore, when a conductor of a wire is inserted into the wiring connecting hole 5, the tip end of the conductor is guided by the V-shaped inclined surface to reach the wiring connecting hole 5, and thus the workability of connecting the wire can be improved.

### Fourth Embodiment

FIG. 7 is a cross-sectional view of a terminal block of an electronic device unit according to a fourth embodiment of the present invention. As illustrated in FIG. 7, the top surface 2a of a terminal block 42 according to the fourth embodiment has no projections or the like and is formed to be flat. On the top surface 2a of the terminal block 42, a belt-shaped groove (a concave portion) 46 is formed for each wiring group that is connected to the terminal block 42. The belt-shaped groove 46 is trapezoidal in cross section, and has a bottom surface 46a arranged in the wiring connecting hole 5 and an inclined surface 46b on both sides of the bottom surface 46a.

Except for the shape of the groove (the concave portion) 46, features of the terminal block 42 according to the fourth embodiment are identical to those of the terminal block 2 according to the first embodiment. Because the inclined surface 46b is arranged in the groove 46, the groove 46 becomes conspicuous and erroneous wiring can be prevented. Furthermore, when a conductor of a wire is inserted into the wiring connecting hole 5, the tip end of the conductor is guided by the inclined surface 46b to reach the wiring connecting hole 5, and thus the workability of connecting the wire can be improved.

### Fifth Embodiment

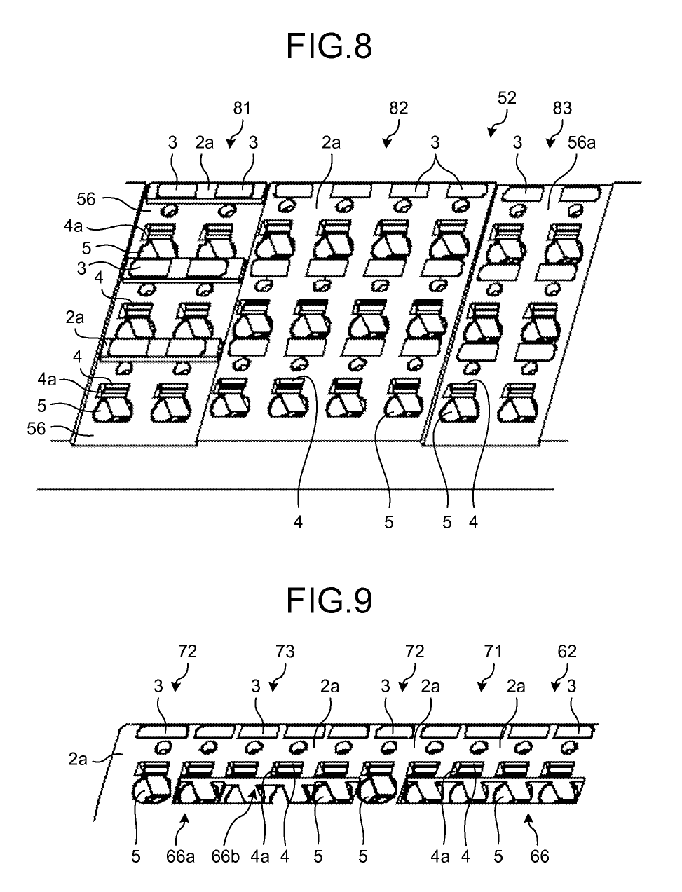

FIG. 8 is a perspective view of a terminal block of an electronic device unit according to a fifth embodiment of the present invention. As illustrated in FIG. 8, a terminal block 52 according to the fifth embodiment includes a first, second, and third regions 81, 82, and 83 for three wiring groups.

In the first and second regions 81 and 82, the top surface 2a of the terminal block 52 has no projections or the like and is formed to be flat. In the first region 81, grooves 56 as belt-shaped concave portions for a first wiring group are formed. A bottom surface of the grooves 56 is parallel to the top surface 2a.

A plurality of the wiring connecting holes 5 having the wiring connection fitting 5a (see FIG. 3) located on a bottom part thereof are arranged on the bottom surface of the grooves 56. Wires in the first wiring group are connected to the wiring connecting holes 5 arranged in the grooves 56. Because the wires in the first wiring group are connected to the wiring connecting holes 5 arranged in one of the grooves 56, erroneous wiring can be prevented.

The rectangular buttonhole 4a is arranged adjacent to each of the wiring connecting holes 5. The opening/closing button 4 for releasing a wire by opening the wiring connection fitting 5a with a pressing operation is accommodated in the buttonhole 4a. Respective wiring display parts 3 corresponding to respective wiring connecting holes 5 are arranged on the top surface 2a near each of the buttonholes 4a in the first region 81.

In the first region 81, because the wiring connecting holes 5 are arranged in the grooves 56 and the opening/closing button 4 is accommodated in the buttonhole 4a, there is no projection from the top surface 2a. Therefore, terminal names of all of the wiring display parts 3 arranged on the top surface 2a in the first region 81 can be printed by one printing process (serigraph).

In the second region 82, the top surface 2a of the terminal block 52 has no projections or the like and is formed to be flat. In the second region 82, no concave portion (groove) for a second wiring group is provided.

A plurality of the wiring connecting holes 5 having the wiring connection fitting 5a (see FIG. 3) located on a bottom part thereof are arranged on the top surface 2a in the second region 82. Wires in the second wiring group are connected to the wiring connecting holes 5 arranged in the second region 82.

In the second region 82, while the wiring connecting holes 5 and the buttonholes 4a are arranged on the top surface 2a, there is no projection from the top surface 2a, and thus terminal names of all of the wiring display parts 3 arranged on the flat top surface 2a in the second region 82 can be printed by one printing process (serigraph).

The third region 83 has no top surface 2a, which is arranged in the first and second regions 81 and 82. In the third region 83, grooves 56a as belt-shaped concave portions for a third wiring group are formed. A bottom surface of the grooves 56a is parallel to the top surface 2a of the first and second regions 81 and 82.

A plurality of the wiring connecting holes 5 having the wiring connection fitting 5a (see FIG. 3) arranged on a bottom part thereof, the buttonholes 4a, and the wiring display parts 3 are provided on the bottom surface of the grooves 56a. Wires in the third wiring group are connected to the wiring connecting holes 5 arranged in the grooves 56a. Because the wires in the third wiring group are connected to the wiring connecting holes 5 arranged in one of the grooves 56a, erroneous wiring can be prevented.

Furthermore, because the second region 82 is sandwiched by the groove 56 of the first region 81 and the groove 56a of the third region 83, the second region 82 can be distinguished from the first and third regions 81 and 83, and erroneous wiring of the second wiring group can be prevented.

In the third region 83, the wiring display parts 3 are arranged on the bottom surface of the grooves 56a, and thus printing of terminal names of the wiring display parts 3 cannot be performed simultaneously with printing of terminal names of the wiring display parts 3 in the first and second regions 81 and 82. Therefore, the printing of terminal names in the third region 83 has to be performed separately from that in the first and second regions 81 and 82.

### Sixth Embodiment

FIG. 9 is a perspective view of a terminal block of an electronic device unit according to a sixth embodiment of the present invention. As illustrated in FIG. 9, a terminal block 62 according to the sixth embodiment includes a first, second, and third regions 71, 72, and 73 for three wiring groups.

In the first, second, and third regions 71, 72, and 73, the top surface 2a of the terminal block 62 has no projections or the like and is formed to be flat. In the first region 71, grooves 66 as belt-shaped concave portions for a first wiring group are formed. A bottom surface of the grooves 66 is parallel to the top surface 2a.

A plurality of the wiring connecting holes 5 having the wiring connection fitting 5a (see FIG. 3) arranged on a bottom part thereof are provided on the bottom surface of the grooves 66. Wires in the first wiring group are connected to a plurality (four) of the wiring connecting holes 5 provided in the grooves 66. Because the wires in the first wiring group are connected to the wiring connecting holes 5 arranged in one of the grooves 66, erroneous wiring can be prevented.

The rectangular buttonhole 4a is arranged adjacent to each of the wiring connecting holes 5. The opening/closing button 4 for releasing a wire by opening the wiring connection fitting 5a with a pressing operation is accommodated in the buttonhole 4a. Respective wiring display parts 3 corresponding to respective wiring connecting holes 5 are arranged in the vicinity of each of the buttonholes 4a of the flat top surface 2a in the first region 71.

The second region 72 is separated into two parts while sandwiching the third region 73. In the second region 72, no concave portion (groove) for a second wiring group is provided. A plurality (two) of the wiring connecting holes 5 having the wiring connection fitting 5a (see FIG. 3) arranged on a bottom part thereof are provided on the top surface 2a of the second region 72. Wires in the second wiring group are connected to a plurality of the wiring connecting holes 5 in the second region 72.

In the third region 73, grooves 66a as belt-shaped concave portions for a third wiring group are formed. A bottom surface of the grooves 66a is parallel to the top surface 2a. In a central part in the grooves 66a, deep grooves 66b that are lower, by a certain degree, than grooves 66a are formed.

Two wiring connecting holes 5 having the wiring connection fitting 5a (see FIG. 3) located on a bottom part thereof are respectively arranged on a bottom surface of the grooves 66a and of the deep grooves 66b. Wires in the third wiring group are connected to the two wiring connecting holes 5 provided in the grooves 66a, and wires of a sub-group in the third wiring group are connected to the two wiring connecting holes 5 provided in the deep grooves 66b. Because the wires in the third wiring group and those in the sub-group are respectively connected to the wiring connecting holes 5 provided in the grooves 66a and the deep grooves 66b, erroneous wiring can be prevented.

The rectangular buttonhole 4a is arranged adjacent to each of the wiring connecting holes 5 in the third region 73. The opening/closing button 4 for releasing a wire by opening the wiring connection fitting 5a with a pressing operation is accommodated in the buttonhole 4a. Respective wiring display parts 3 corresponding to respective wiring connecting holes 5 are provided in the vicinity of each of the buttonholes 4a of the flat top surface 2a in the third region 73.

In the second region 72, no concave portion (groove) is provided. Therefore, the second region 72 can be distinguished from the first and third regions 71 and 73, and erroneous wiring of the second wiring group can be prevented. In addition, because the first, second, and third regions 71, 72, and 73 share one flat top surface 2a and there is no projection, terminal names of the wiring display parts 3 can be printed by one printing process (serigraph).

### INDUSTRIAL APPLICABILITY

As described above, the terminal block and the electronic device unit according to the present invention are suitable for a terminal block and an electronic device unit in which a large number of wires are connected.

### REFERENCE SIGNS LIST

1, 21 CASE
2, 32, 42, 52, 62 TERMINAL BLOCK
2a TOP SURFACE
3 WIRING DISPLAY PART
4 OPENING/CLOSING BUTTON
4a BUTTONHOLE
4b COMMUNICATION OPENING
5 WIRING CONNECTING HOLE
5a WIRING CONNECTION FITTING
6, 36, 46, 56, 56a, 66, 66a GROOVE (CONCAVE PORTION)
66b DEEP GROOVE
7 EDGE PART
8 STEPPED PART
10 VENTILATION HOLE
11 WIRING SUBSTRATE
71, 81 FIRST REGION
72, 82 SECOND REGION
73, 83 THIRD REGION
91, 92 ELECTRONIC DEVICE UNIT

1. A terminal block comprising:
a top surface formed to be flat;
a concave portion formed on the top surface; and
a plurality of wiring connecting holes provided in the concave portion.

2. The terminal block according to claim 1, wherein wiring display parts corresponding to the wiring connecting holes are provided on the top surface.

3. The terminal block according to claim 1, wherein the concave portion is provided in plural for each wiring group.

4. The terminal block according to claim 1, wherein a buttonhole is arranged adjacent to the wiring connecting holes and an opening/closing button for opening and closing a wiring connection fitting located on a bottom part of the wiring connecting holes is accommodated in the buttonhole.

5. The terminal block according to claim 1, wherein the concave portion is a belt-shaped groove.

6. The terminal block according to claim 1, wherein a bottom surface of the groove is inclined towards a width direction of the groove.

7. The terminal block according to claim 6, wherein the groove is a V-shaped groove.

8. The terminal block according to claim 5, wherein the groove is a trapezoidal groove.

9. An electronic device unit comprising:
a wiring substrate having a terminal block that includes:
a top surface formed to be flat;
a concave portion formed on the top surface;
a plurality of wiring connecting holes provided in the concave portion; and
electronic components mounted thereon; and
a case covering the wiring substrate.

10. The electronic device unit according to claim 9, wherein electronic components that cannot be mounted on the wiring substrate due to overflow are mounted on a bottom surface of the terminal block.

11. The electronic device unit according to claim 9, wherein a ventilation hole is provided in the case.
